(19) United States
(12) Patent Application Publication
(10) Pub. No.: US 2021/0325737 A1
(43) Pub. Date: Oct. 21, 2021

(54) DISPLAY PANEL, DISPLAY APPARATUS AND ANTI-PEEPING METHOD

(71) Applicants: FUZHOU BOE OPTOELECTRONICS TECHNOLOGY CO., LTD., Fuzhou, Fujian (CN); BOE Technology Group Co., Ltd., Beijing (CN)

(72) Inventors: Honglin ZHANG, Beijing (CN); Meiying LI, Bejing (CN); Lifeng LI, Beijing (CN); Baoqiang WANG, Beijing (CN); Wenchao WANG, Beijing (CN)

(73) Assignees: Fuzhou BOE Optoelectronics Technology Co., Ltd., Fuzhou, Fujian (CN); BOE Technology Group., Ltd, Beijing (CN)

(21) Appl. No.: 16/492,740

(22) PCT Filed: Dec. 12, 2018
(86) PCT No.: PCT/CN2018/120606

§ 371 Date: Sep. 10, 2019

(51) Int. Cl. G02F 1/1343; G02F 1/133; G02F 1/137

(52) U.S. Cl. CPC G02F 1/134309; G02F 1/13306; G02F 1/133514; G02F 1/13706; G02F 1/13712; G02F 1/13439

(57) ABSTRACT

The disclosure relates to a display panel. The display panel may include a first substrate, a second substrate opposite the first substrate, a liquid crystal layer between the first substrate and the second substrate, a first electrode on a side of the first substrate facing the liquid crystal layer, a second electrode between the liquid crystal layer and the first electrode, the second electrode being insulated from the first electrode, and an anti-peeping electrode on a side of the second substrate facing the liquid crystal layer.

### CROSS-REFERENCE TO RELATED APPLICATIONS

This application claims benefit of the filing date of Chinese Patent Application No. 201810997153.6 filed on Aug. 29, 2018, the disclosure of which is hereby incorporated in its entirety by reference.

### TECHNICAL FIELD

The present disclosure relate to the field of display technologies, and in particular, to a display panel, a display apparatus, and an anti-peeping method for the display apparatus.

### BACKGROUND

Currently, display apparatuses are becoming more and more popular, and people are increasingly relying on the use of display apparatuses to handle certain transactions. In order to protect privacy of information not peeped by others, the security of information is increasingly required. Therefore, various anti-peeping techniques are widely used in display apparatuses.

### BRIEF SUMMARY

An embodiment of the present disclosure provides a display panel. The display panel may include a first substrate, a second substrate opposite the first substrate, a liquid crystal layer between the first substrate and the second substrate, a first electrode on a side of the first substrate facing the liquid crystal layer, a second electrode between the liquid crystal layer and the first electrode, the second electrode being insulated from the first electrode, and an anti-peeping electrode on a side of the second substrate facing the liquid crystal layer.

Optionally, the display panel further include a control apparatus, wherein the control apparatus is configured to control a voltage difference between the anti-peeping electrode and the first electrode or the second electrode to cause the display panel to operate in an anti-peeping mode or a non-anti-peeping mode.

Optionally, one of the first electrode and the second electrode is a common electrode and the other one is a pixel electrode, the control apparatus is configured to generate a first voltage difference between the anti-peeping electrode and the common electrode in the anti-peeping mode, and to generate a second voltage difference between the anti-peeping electrode and the common electrode or to suspend the anti-peeping electrode in the non-anti-peeping mode, the second voltage difference being smaller than the first voltage difference.

Optionally, the anti-peeping electrode comprises a surface electrode or a plurality of strip-shaped first sub-electrodes arranged at intervals.

Optionally, the first substrate comprises an array substrate and the second substrate comprises a color film substrate.

Optionally, the display panel further includes a first insulating layer between the first electrode and the second electrode.

Optionally, one of the first electrode and the second electrode is a surface electrode, and the other comprises a plurality of strip-shaped second sub-electrodes arranged at intervals.

Optionally, the anti-peeping electrode comprises the plurality of first sub-electrodes, and orthographic projections of the plurality of first sub-electrodes on the second substrate overlap orthographic projections of the plurality of second sub-electrodes on the second substrate, respectively.

Optionally, the anti-peeping electrode comprises the plurality of first sub-electrodes, orthographic projections of the plurality of first sub-electrodes on the second substrate and orthographic projections of the plurality of second sub-electrodes on the second substrate do not overlap.

Optionally, the anti-peeping electrode includes the plurality of first sub-electrodes, at least one of the plurality of first sub-electrodes has a width in a range of about 3.5 μm to about 6.5 μm, and an interval between adjacent first sub-electrodes is in a range of about 1.5 μm to about 5.5 μm.

Optionally, the anti-peeping electrode has a thickness in a range of about 100 Å to about 1000 Å.

Optionally, the anti-peeping electrode comprises a transparent conductive material.

Optionally, the liquid crystal layer comprises positive liquid crystals, the first voltage difference is in a range from about 2.8V to about 4.5V, and the second voltage difference is less than about 2.5V.

Optionally, the liquid crystal layer comprises negative liquid crystals, and wherein the first voltage difference is in a range of about 6V to about 15V, and the second voltage difference is less than about 3V.

Another example of the present disclosure is a display apparatus comprising the display panel according to one embodiment of the present disclosure.

Another example of the present disclosure is an anti-peeping method for the display panel according to one embodiment of the present disclosure. The method may include controlling the voltage difference between the anti-peeping electrode and the first electrode or the second electrode to operate the display panel in the anti-peeping mode or the non-anti-peeping mode.

Optionally, controlling the voltage difference between the anti-peeping electrode and the first electrode or the second electrode to operate the display panel in the anti-peeping mode comprises generating a first voltage difference between the anti-peeping electrode and the first electrode or the second electrode.

Optionally, controlling the voltage difference between the anti-peeping electrode and the first electrode or the second electrode to operate the display panel in the non-anti-peeping mode comprises generating a second voltage difference which is smaller than the first voltage difference between the anti-peeping electrode and the first electrode or the second electrode, or applying no voltage on the anti-peeping electrode.

Optionally, in a case where the liquid crystal layer comprises positive liquid crystals, the first voltage difference is in a range from about 2.8V to about 4.5V and the second voltage difference is less than about 2.5V; and in the case where the liquid crystal layer comprises negative liquid crystals, the first voltage difference is in a range from about 6V to about 15V and the second voltage difference is less than about 3V.

Optionally, the method may include applying a voltage of Xₒₚ V on the common electrode, applying a DC voltage on the anti-peeping electrode, and applying an AC voltage on the pixel electrode, the AC voltage varying in a range between 0V to 2XₒₚV. Xₒₚ is a voltage of the pixel electrode corresponding to the maximum brightness of the display panel.

### BRIEF DESCRIPTION OF THE DRAWINGS

The drawings described herein are for purposes of illustration only of the selected embodiments, and are not intended to limit the scope of the present disclosure.

FIG. 1 is a schematic cross-sectional view of a display panel according to one embodiment of the present disclosure;

FIG. 2 is a schematic cross-sectional view of a display panel according to one embodiment of the present disclosure;

FIG. 3a is a schematic view of a display panel in a dark state in an non-anti-peeping mode according to one embodiment of the present disclosure;

FIG. 3b is a schematic view of a display panel in a dark state in an anti-peeping mode according to one embodiment of the present disclosure;

FIG. 4 is a schematic cross-sectional view of a display panel according to one embodiment of the present disclosure;

FIG. 5 is a schematic cross-sectional view of a display panel according to one embodiment of the present disclosure;

FIG. 6 shows Gamma curves of the anti-peeping mode and the non-anti-peeping mode according to one embodiment of the present disclosure;

FIG. 7 shows Gamma curves of the anti-peeping mode and the non-anti-peeping mode according to one embodiment of the present disclosure;

FIG. 8 is a schematic illustration of a display apparatus according to some embodiments of the present disclosure;

FIG. 9 schematically shows a flow chart of an anti-peeping method for a display panel of the ADS mode according to one embodiment of the present disclosure.

### DETAILED DESCRIPTION

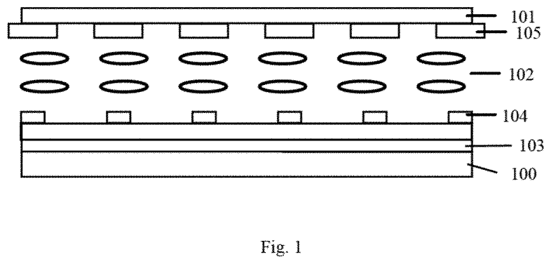

The present disclosure will be described in further detail with reference to the accompanying drawings and embodiments in order to provide a better understanding by those skilled in the art of the technical solutions of the present disclosure. Throughout the description of the disclosure, reference is made to FIGS. 1-9. When referring to the figures, like structures and elements shown throughout are indicated with like reference numerals.

It is to be noted that the following figures and examples are not intended to limit the scope of the disclosure. Where specific components of the disclosure may be implemented in part or in whole using known components (or methods or processes), only those portions of the known components (or methods or processes) required for understanding the disclosure will be described. Detailed descriptions of other parts of such known components will be omitted so as not to obscure the present disclosure. Further, the various embodiments are intended to encompass any present and future equivalent to the components herein.

In the embodiment of the present disclosure, the articles “a,” “an,” “the,” and “said” are intended to mean the presence of one or more elements. Unless otherwise stated, the meaning of “multiple” is two or more. The terms “comprising,” “including,” and “having” are meant to be inclusive and mean that there may be additional elements in addition to the listed elements. The terms “first,” “second,” “third,” etc. are used for descriptive purposes only and is not to be construed as indicating or implying relative importance and order of formation.

In the related anti-peeping technology, an anti-peeping film can be attached to a surface of a display screen to achieve the purpose of anti-peeping. In this way, it is necessary to repeatedly remove and attach the anti-peeping film in order to switch between the anti-peeping mode and the non-anti-peeping mode. Specifically, when used in an environment where anti-peeping is required, an anti-peeping film is attached. However, when used in an environment where anti-peeping is not required, the anti-peeping film is torn off. This method is very inconvenient to use, and it is easy to cause bubbles between the anti-peeping film and the display screen during the attaching process, thereby affecting appearance of the screen. Another anti-peeping technique is to switch between the anti-peeping mode and the non-anti-peeping mode by adding a control apparatus outside the display apparatus or at the backlight. However, this method is prone to the problem that the display is too bulky and costly.

Reducing viewing angle of the display panel is one of the common means to achieve anti-peeping. Typically, the viewing angle of the display panel corresponds to a range of viewing angles with a contrast greater than or equal to 10. Therefore, reducing the contrast of the display panel can reduce the viewing angle of the display panel, thereby achieving the purpose of anti-peeping. There may be two ways to reduce the contrast: i) reduce the brightness of the display panel in the bright state; and/or ii) increase the brightness of the display panel in the dark state. When the display panel is in a dark state, the change of brightness is relatively small as the viewing angle changes. Accordingly, it is easy to control the brightness in the dark state. Moreover, as the brightness in the dark state changes slightly, the contrast changes greatly. Therefore, in some embodiments of the present disclosure, deflection of the liquid crystal molecules is controlled by adding an additional voltage to increase the brightness of the display panel in a dark state.

According to some embodiments of the present disclosure, a display panel is provided. FIG. 1 schematically shows a cross-sectional view of a display panel according to some embodiments of the disclosure. As shown in FIG. 1, the display panel may include a first substrate 100; a second substrate 101 disposed opposite the first substrate 100; a liquid crystal layer 102 disposed between the first substrate 100 and the second substrate 101; a first electrode located on a side of the first substrate 100 facing the liquid crystal layer 102; a second electrode 104 located between the liquid crystal layer 102 and the first electrode 103; and an anti-peeping electrode 105 located on the side of the second substrate 101 facing the liquid crystal layer 102. The second electrode 104 is insulated from and spaced apart from the first electrode 103.

In some embodiments of the present disclosure, the anti-peeping electrode 105 is additionally formed on the second substrate 101 of the display panel. In operation, the brightness of the display panel in the dark state can be improved by appropriately controlling the voltage difference between the anti-peeping electrode 105 and the first electrode 103 or the second electrodes 104. Therefore, the contrast of the display panel can be reduced, thereby achieving the purpose of anti-peeping. As such, it is simple to manufacture the display panel and the cost of manufacturing the display panel is low. Also, it is convenient to switch between the anti-peeping mode and the non-anti-peeping mode by controlling the voltage applied to the anti-peeping electrode 105.

In one embodiment of the present disclosure, the first substrate may be an array substrate, and the second substrate may be a color film substrate. In this case, the first electrode and the second electrode are formed on the array substrate, and the anti-peeping electrode is formed on the color film substrate.

The display panel can be implemented by ADS (Advanced Super Dimension Switch) technology or HADS (High Transmittance Advanced Super Dimension Switch) technology. In the display panel of the ADS mode, the first electrode serves as a common electrode, the second electrode serve as a pixel electrode, and the pixel electrode is formed above the common electrode. For the display panel of the ADS mode, since the common electrode does not cover data lines and scan lines, the load of the data lines and the scan line is relatively small, which is more suitable for a large-sized design. In the display panel of the HADS mode, the first electrode serves as a pixel electrode, the second electrode serves as a common electrode, and the common electrode is formed above the pixel electrode. The display panel of the HADS mode has a higher aperture ratio and is suitable for mobile products.

The present disclosure will be described in detail below with reference to specific embodiments mainly taking the display panel of the ADS mode as an example. Other aspects of these embodiments are equally applicable to display panels of the HADS mode, except that the location and shape of the common and pixel electrodes may be different from those in the display panels of the ADS mode.

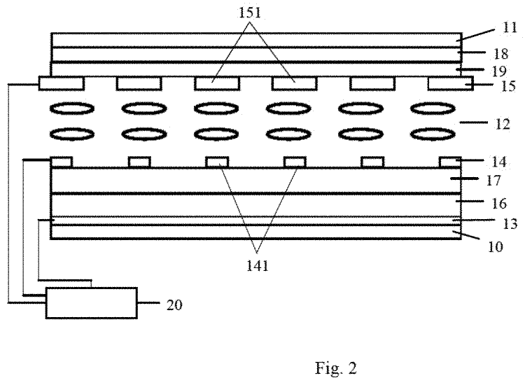

FIG. 2 schematically shows a cross-sectional view of a display panel in the first embodiment of the present disclosure. The display panel is a display panel of the ADS mode. In this embodiment, the first substrate serves as an array substrate, the second substrate serves as a color film substrate, the first electrode serves as a common electrode, and the second electrode serves as a pixel electrode. As shown in FIG. 2, the display panel may include an array substrate 10; a color film substrate 11 disposed opposite the array substrate 10; a liquid crystal layer 12 between the array substrate 10 and the color film substrate 11; a common electrode 13 on one side of the array substrate 10 facing the liquid crystal layer 12; a pixel electrode 14 located between the liquid crystal layer 12 and the common electrode 13 and insulated from the common electrode 13; and an anti-peeping electrode 15 on the side of the color film substrate 11 facing the liquid crystal layer 12.

As shown in FIG. 2, the display panel may further include a first insulating layer 16 and a passivation layer 17 (PVX) between the common electrode 13 and the pixel electrode 14, and a color resist layer 18 and an overcoat layer (OC) 19 between the color film substrate 11 and the anti-peeping electrode 15.

In the embodiment shown in FIG. 2, the anti-peeping electrode 15 may include a plurality of strip-shaped first sub-electrodes 151 arranged at intervals. The anti-peeping electrode 15 may be formed of a transparent conductive material. In one embodiment, a transparent conductive film may be coated on the OC layer by PVD (Physical Vapor Deposition), and then the transparent conductive film may be etched into strips to form a plurality of strip-shaped first sub-electrodes 151. In one embodiment, the width of each of the first sub-electrodes 151 may be in a range from about 3.5 μm to about 6.5 μm, preferably from about 5.0 μm to about 6.5 μm and the interval between adjacent first sub-electrodes 151 may be in a range from about 1.5 μm to about 5.5 μm, preferably from about 1.5 μm to about 3.0 μm.

In an exemplary embodiment, the anti-peeping electrode 15 may have a thickness in a range from about 100 Å and about 1000 Å, preferably about 400 Å to about 800 Å.

The common electrode 13 and the pixel electrode 14 may be transparent electrodes, for example, formed of transparent ITO. The common electrode 13 may be a surface electrode, and the pixel electrode 14 may include a plurality of strip-shaped second sub-electrodes 141 arranged at intervals. The surface electrode means that it is a plate electrode covering the whole surface.

In the illustrated embodiments, the first sub-electrodes 151 of the anti-peeping electrode 15 are in one-to-one correspondence with the respective second sub-electrodes 141 of the pixel electrode 14. That is, the orthographic projection of each of the first sub-electrodes 151 of the anti-peeping electrode 15 on the array substrate 10 overlaps with the orthographic projection of the respective second sub-electrode 141 of the pixel electrode 14 on the array substrate 10. Alternatively, the width of the first sub-electrode 151 may be greater than the width of the second sub-electrode 141.

In one embodiment of the present disclosure, the display panel may further include a control apparatus 20 configured to control a voltage difference between the anti-peeping electrode 15 and the common electrode 13 so that the display panel can operate in an anti-peeping mode or a non-anti-peeping mode. The control apparatus may include an electrical circuit or hardware. In one embodiment, the control apparatus 20 is a driving device of an existing circuit.

In the anti-peeping mode, the control apparatus 20 controls the voltage of the anti-peeping electrode 15 and the common electrode 13 such that there is a first voltage difference between the anti-peeping electrode 15 and the common electrode 13. In this case, in addition to the electric field generated by the common electrode 13 and the pixel electrode 14 for causing the display panel to display an image, an additional electric field is generated between the anti-peeping electrode 15 and the common electrode 13. The additional electric field can increase at least the brightness in the dark state to reduce the contrast of the display panel so that the display panel has an anti-peeping effect.

The control apparatus 20 can also have a second voltage difference between the anti-peeping electrode 15 and the common electrode 13 that is less than the first voltage difference. Since the second voltage difference is relatively small, its effect on the contrast of the display panel is relatively small, and the anti-peeping effect is not obvious. In this case, it is equivalent to the display panel being in the non-anti-peeping mode. In another embodiment, the display panel can be placed in a non-anti-peeping mode by suspending the anti-peeping electrode 15. Here, “suspending” means that no voltage is applied to the anti-peeping electrode 15. As a result of suspending the anti-peeping electrode 15, no electric field is generated between the anti-peeping electrode 15 and the common electrode 13, that is, there is no voltage difference. In this case, the anti-peeping electrode 15 neither affects the rotational status of the liquid crystal molecules nor the contrast of the display panel. Accordingly, the anti-peeping effect is not generated.

In some embodiments of the present disclosure, the liquid crystals in the liquid crystal layer 12 may be positive liquid crystals or negative liquid crystals. In the case of positive liquid crystals, the first voltage difference may be about 2.8V to about 4.5V, and the second voltage difference may be less than about 2.5V. In the case of negative liquid crystals, the first voltage difference may be about 6.0 V to about 15V, and the second voltage difference may be less than about 3V.

In one embodiment, the common electrode may be applied with a voltage of Xₒₚ V. The anti-peeping electrode 15 may be applied with a DC voltage (eg, in the case of positive liquid crystals, a DC voltage of 2.8V-4.5V may be applied). The pixel electrode 14 is applied with an alternating voltage that varies in a range between 0V and 2 Xₒₚ V. Xₒₚ is the voltage of the pixel electrode 14 corresponding to the maximum brightness of the display panel. In one embodiment of the present disclosure, the value of Xₒₚ can be obtained by performing a simulation test using software with appropriate parameters.

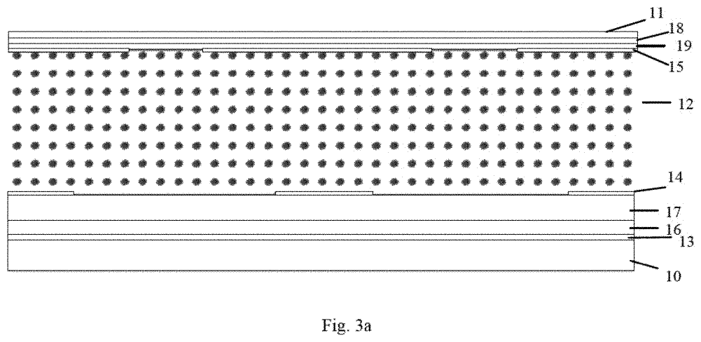

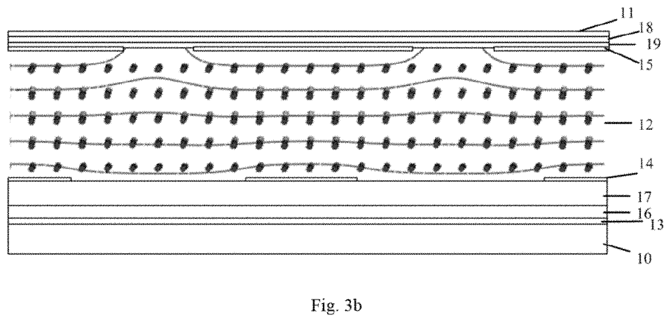

FIG. 3a schematically shows a display panel in a dark state and in a non-anti-peeping mode in one embodiment of the present disclosure; FIG. 3b schematically shows a display panel in a dark state and in an anti-peeping mode in one embodiment of the present disclosure.

As shown in FIG. 3a, for the display panel in the dark state and in the non-anti-peeping mode, no voltage is applied to the anti-peeping electrode 15, or the voltage difference between the anti-peeping electrode 15 and the common electrode 13 is small. Accordingly, there is no electric field or a very weak electric field in the liquid crystal layer 12. The polarization direction of the polarized light incident on the liquid crystal layer 12 through the lower polarizing plate is parallel or perpendicular to the optical axis of the liquid crystals. Only the e-light or the o-light exists in the liquid crystal layer 12, and there is no birefringence phenomenon. Thus, the polarization status of the incident light is not changed. Since the transmission axes directions of the upper polarizing plate and the lower polarizing plate of the display panel are perpendicular to each other, light in the liquid crystal layer 12 cannot be emitted from the upper polarizing plate. In this case, the brightness of the display panel in the dark state is not improved, the contrast is not changed, and thus there is no anti-peeping effect.

As shown in FIG. 3b, in the anti-peeping mode, a big voltage difference exists between the anti-peeping electrode 15 and the common electrode 13 by applying a voltage on the anti-peeping electrode 15. The liquid crystal layer 12 has a strong electric field. Under the action of the electric field, the liquid crystal molecules are no longer parallel to the substrate, but are tilted at a certain angle along the direction of the electric field. The liquid crystal layer 12 changes the polarization state of the incident light such that the polarization state of the incident light after passing through the liquid crystal layer is not perpendicular to the transmission axis of the upper polarizing plate. Accordingly, a part of the light can be emitted from the upper polarizing plate. In this case, the brightness of the display panel in the dark state is increased, and the contrast is reduced, so that it can function as anti-peeping.

The display panel provided by the embodiment of the present disclosure only needs to add the anti-peeping electrode on the color film substrate. This embodiment is simple to be implemented, low in cost, and does not affect the appearance of the display panel. Further, by controlling the voltage difference between the common electrode and the anti-peeping electrode (for example, controlling the voltage of the anti-peeping electrode in the case where the voltage of the common electrode is constant), the display panel can be made to conveniently switch between the anti-peeping mode and the non-anti-peeping mode, so that it is easy to operate the display panel.

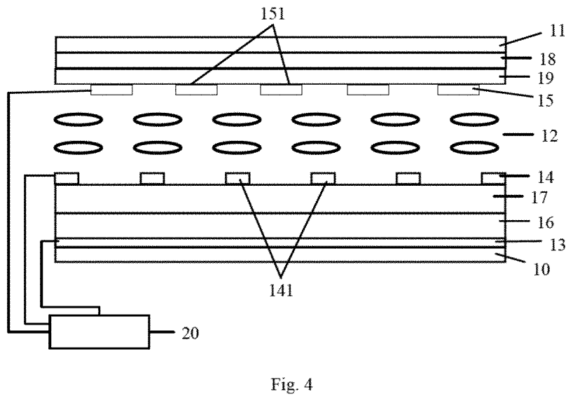

FIG. 4 schematically shows a cross-sectional view of a display panel in one embodiment of the present disclosure. In the embodiment shown in FIG. 4, the respective first sub-electrodes 151 of the anti-peeping electrode 15 are located respectively above the intervals between the second sub-electrodes 141 of the pixel electrode 14. That is, in this embodiment shown in FIG. 4, the orthographic projection of each of the first sub-electrodes 151 of the anti-peeping electrode 15 on the array substrate 10 and the orthographic projection of each of the second sub-electrodes 141 of the pixel electrode 14 on the array substrate 10 do not overlap. The other structure of the display panel of the embodiment shown in FIG. 4 is the same as that of the embodiment shown in FIG. 2. Therefore, for the explanation of the display panel shown in FIG. 4, reference may be made to the explanation of the display panel shown in FIG. 2.

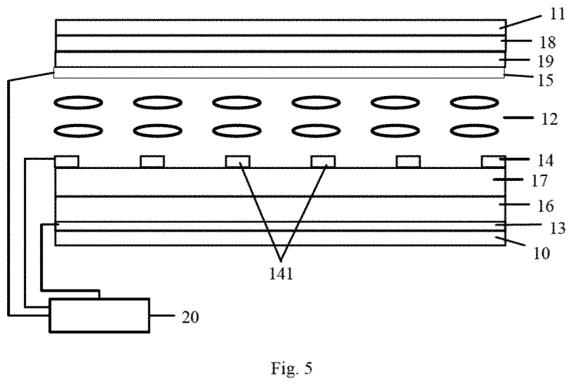

FIG. 5 schematically shows a cross-sectional view of a display panel in one embodiment of the present disclosure. In the embodiment shown in FIG. 5, the anti-peeping electrode 15 is a surface electrode instead of a strip electrode. That is, the anti-peeping electrode is a layer of transparent conductive electrode. The other structure is the same as that of the display panel of the embodiment shown in FIG. 2. Therefore, for the explanation of the display panel shown in FIG. 5, reference may be made to the explanation of the display panel shown in FIG. 2.

In order to make the objects, technical solutions and advantages of the present disclosure more clear, the display panel provided by the present disclosure will be described in detail below with reference to several examples of software simulation.

It should be noted that since the display panel is simulated by software, it is not clear before the simulation how much voltage is applied to the common electrode and the pixel electrode to maximize the brightness of the display panel to be simulated, and the voltage Vop corresponds to the maximum brightness can be tested only during the simulation process. Therefore, in the following simulation example, a DC voltage of 0V is applied to the common electrode, and an AC voltage of 0-10 V is applied to the pixel electrode. It should be understood that when actually producing a product, a DC voltage of Xₒₚ V obtained during the simulation test may be applied to the common electrode, and a voltage of 0-2 Xₒₚ V may be applied to the pixel electrode.

### Example 1

In example 1, the display panel is a display panel of a HADS mode. The liquid crystals in the liquid crystal layer are positive liquid crystals. The anti-peeping electrode includes a plurality of strip-shaped first sub-electrodes. The first electrode serves as a pixel electrode and includes a plurality of sub-electrodes, and each sub-electrode corresponds to one pixel. The second electrode serves as a common electrode, and the second electrode includes a plurality of strip-shaped second sub-electrodes. The first sub-electrodes of the anti-peeping electrode are located directly above the second sub-electrodes of the common electrode respectively.

Other parameters and software simulation results of the HADS display panel having an anti-peeping structure with strip-shaped anti-peeping electrodes and the display panel of the normal HADS mode (Normal HADS structure) are listed in Table 1 below:

From the simulation results in Table 1, it is known that for the display panel under the normal HADS structure (without the anti-peeping electrode) and the non-anti-peeping mode (with the anti-peeping electrode but no voltage applied), the left field angle, the right field angle, the upper field angle and the lower field angle are all 89°. For the display panel in the anti-peeping mode (with the anti-peeping electrode, 3V applied), the left and right field angles are reduced to 32° and 29° respectively, so an excellent anti-peeping effect can be achieved.

In the TFT-LCD, in order to express the consistency of the brightness actual perceived by the human eye and the brightness of the display panel outputted under a specific grayscale, the curve defining the relationship between the human eye perceived and the brightness change is a Gamma curve, and the Gamma curve formula can be expressed as:

Transmittance=Brightness at a specific grayscale/the Highest Brightness=(Specific Grayscale/Total Grayscale)^{Y}

Wherein, Y is a Gamma value. When the gamma value is changed between 2.0 and 2.4, the human eye can correctly perceive the change in brightness.

In one embodiment, for an 8-bit display panel, the 8-bit display panel has a total of 256 grayscales of L0-L255. The screens displayed in each grayscale correspond to different brightness respectively. The lowest brightness is in the L0 grayscale, and the lowest brightness is marked as T0. The highest brightness is in the L255 grayscale, and the highest brightness is marked as T256. The brightness in the grayscale La between L0 and L255 is marked as Ta. The Gamma curve formula for this 8-bit display panel can be expressed as:

Transmittance=Ta/T255=(La/256)^{Y}

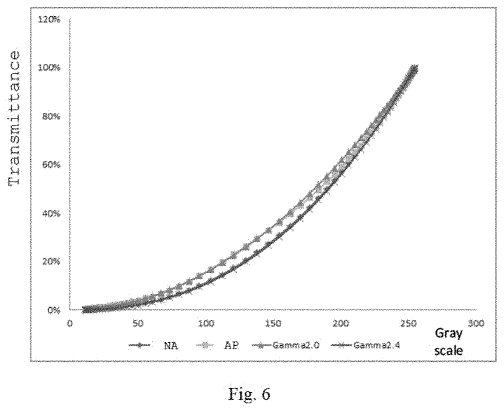

FIG. 6 shows Gamma curves in the anti-peeping (AP) mode and the non-anti-peeping (NA) mode for Example 1. As shown in FIG. 6, the Gamma curves in both the anti-peeping mode and the non-anti-peeping mode have almost no deviation from the range between the Gamma 2.0 curve and the Gamma 2.4 curve.

### Example 2

In this example, the display panel is an ADS display panel. The liquid crystals in the liquid crystal layer are positive liquid crystals. The anti-peeping electrode is a surface electrode. The first electrode serves as a common electrode, which is a surface electrode. The second electrode serves as a pixel electrode, which includes a plurality of strip-shaped second sub-electrodes.

The other parameters and software simulation results of the ADS display panel having an anti-peeping structure with the planar anti-peeping electrode and the display panel of the normal ADS mode (Normal ADS structure) are listed in Table 2 below:

From the simulation results in Table 2, it is known that for the display panel under the normal ADS structure (without the anti-peeping electrode) and the non-anti-peeping mode (with the anti-peeping electrode but no voltage applied), the left field angle, the right field angle, the upper field angle and the lower field angle are all 89°. For the display panel in the anti-peeping mode (with the anti-peeping electrode, 3V applied), the left and right field angles are reduced to 36° and 29° respectively, so that an excellent anti-peeping effect can be obtained.

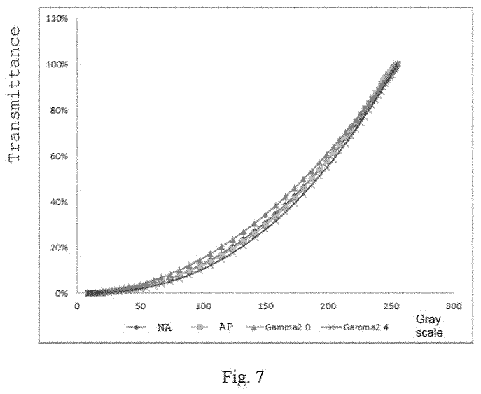

FIG. 7 shows Gamma curves in the anti-peeping (AP) mode and the non-anti-peeping (NA) mode for Example 2. As shown in FIG. 7, the Gamma curves in both the anti-peeping (AP) mode and the non-anti-peeping (NA) mode have almost no deviation from the range between the Gamma 2.0 curve and the Gamma 2.4 curve.

In another example of the present disclosure, a display apparatus is also provided. The display apparatus may include the display panel according to one embodiment of the present disclosure, such as a display panel of one or more of the embodiments disclosed in detail above. Thus, description of embodiments of the display panel above may be referred to for some embodiments of the display apparatus.

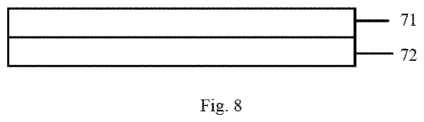

FIG. 8 is a schematic illustration of a display apparatus in some embodiments of the present disclosure. As shown in FIG. 8, the display apparatus may include a display panel 71 and a backlight module 72 located on the light incident side of the display panel. The display panel 71 can be a display panel of one or more embodiments disclosed in detail above, such as the display panel of the embodiment illustrated in FIG. 3, 4, or 5. The backlight module can be any backlight module suitable for use as a backlight for a display panel as known in the art. As a non-limiting example, the backlight module may include a light guide plate and a backlight located on a light incident side of the light guide plate. The backlight can be, for example, an LED light source or a laser source. The light guide plate may be made of an acrylic material, a resin material, or a glass material.

In yet another example of the present disclosure, an anti-peeping method is also provided. The anti-peeping method can be used for a display panel according to one embodiment of the present disclosure, such as a display panel of one or more embodiments disclosed in detail above. Thus, for an alternative embodiment of the method, reference may be made to an embodiment of a display panel above.

The anti-peeping method provided according to one embodiment of the present disclosure may include controlling a voltage difference between the anti-peeping electrode and the first electrode or the second electrode to operate the display panel in an anti-peeping mode or a non-anti-peeping mode.

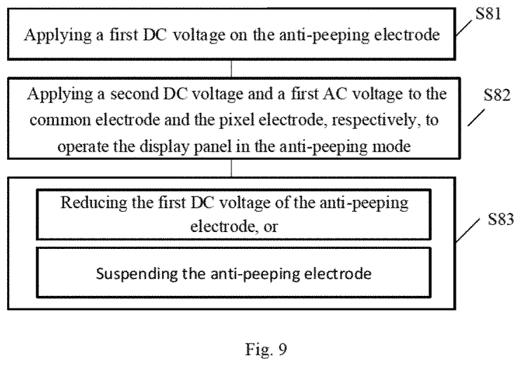

FIG. 9 schematically shows a flow chart of an anti-peeping method for a display panel of the ADS mode according to one embodiment of the present disclosure. In the display panel of the ADS mode, the first electrode is a common electrode and the second electrode is a pixel electrode. As shown in FIG. 9, the anti-peeping method may include steps S81-S83:

Step S81 includes applying a first DC voltage to the anti-peeping electrode. In this step, in the case of positive liquid crystals, the first DC voltage may range from about 2.8V to about 4.5V. In the case of negative liquid crystals, the first DC voltage may range from about 6V to about 15V.

Step S82 includes applying a second DC voltage and a first AC voltage to the common electrode and the pixel electrode, respectively, to operate the display panel in the anti-peeping mode. In this step, a voltage of 0V may be applied to the common electrode to generate a first voltage difference between the anti-peeping electrode and the common electrode. An alternating voltage varying in a range between 0V and 2Xₒₚ V is applied to the pixel electrode to generate an alternating electric field that controls the deflection of the liquid crystals in the liquid crystal layer to drive the pixel. Xₒₚ is the voltage of the pixel electrode when the display panel has maximum brightness.

Step S83 includes reducing the first DC voltage of the anti-peeping electrode or suspending the anti-peeping electrode to operate the display panel in the non-anti-peeping mode. In this step, the voltage of the anti-peeping electrode is reduced, so that the anti-peeping electrode and the common electrode have a second voltage difference smaller than the first voltage difference. Accordingly, the display panel can be operated in the non-anti-peeping mode by weakening the anti-peeping effect. Alternatively, the anti-peeping electrode can be directly suspended. As such, the display panel can also be operated in the non-anti-peeping mode.

As has been described above, the display panel of the HADS mode is different from the display panel of the ADS mode in that, in the display panel of the HADS mode, the first electrode serves as a pixel electrode, and the pixel electrode may include a plurality of sub-electrodes, each of which corresponds to a pixel. The second electrode serves as a common electrode, and the common electrode may include a plurality of strip-shaped second sub-electrodes. The other structures are the same as those in the ADS mode, so the same anti-peeping method can be used, and details thereof are not described herein again.

The flow chart depicted in the present disclosure is merely an example. Many variations of the flowchart or the steps described therein may exist without departing from the spirit of the disclosure. For example, the steps may be performed in a different order, or steps may be added, deleted or modified. These variations are considered to be part of the claimed aspect.

The principle and the embodiment of the present disclosures are set forth in the specification. The description of the embodiments of the present disclosure is only used to help understand the method of the present disclosure and the core idea thereof. Meanwhile, for a person of ordinary skill in the art, the disclosure relates to the scope of the disclosure, and the technical scheme is not limited to the specific combination of the technical features, and also should covered other technical schemes which are formed by combining the technical features or the equivalent features of the technical features without departing from the inventive concept. For example, technical scheme may be obtained by replacing the features described above as disclosed in this disclosure (but not limited to) with similar features.

1. A display panel, comprising:
a first substrate;
a second substrate opposite the first substrate;
a liquid crystal layer between the first substrate and the second substrate;
a first electrode on a side of the first substrate facing the liquid crystal layer;
a second electrode between the liquid crystal layer and the first electrode, the second electrode being insulated from the first electrode; and
an anti-peeping electrode on a side of the second substrate facing the liquid crystal layer.

2. The display panel according to claim 1, further comprising a control apparatus, wherein the control apparatus is configured to control a voltage difference between the anti-peeping electrode and the first electrode or the second electrode to cause the display panel to operate in an anti-peeping mode or a non-anti-peeping mode.

3. The display panel according to claim 2, wherein one of the first electrode and the second electrode is a common electrode and the other one is a pixel electrode, the control apparatus is configured to generate a first voltage difference between the anti-peeping electrode and the common electrode in the anti-peeping mode, and to generate a second voltage difference between the anti-peeping electrode and the common electrode or to suspend the anti-peeping electrode in the non-anti-peeping mode, the second voltage difference being smaller than the first voltage difference.

4. The display panel according to claim 3, wherein the anti-peeping electrode comprises a surface electrode or a plurality of strip-shaped first sub-electrodes arranged at intervals.

5. The display panel according to claim 4, wherein the first substrate comprises an array substrate and the second substrate comprises a color film substrate.

6. The display panel according to claim 5, further comprising a first insulating layer between the first electrode and the second electrode.

7. The display panel according to claim 5, wherein one of the first electrode and the second electrode is a surface electrode, and the other comprises a plurality of strip-shaped second sub-electrodes arranged at intervals.

8. The display panel according to claim 7, wherein the anti-peeping electrode comprises the plurality of first sub-electrodes, and orthographic projections of the plurality of first sub-electrodes on the second substrate overlap orthographic projections of the plurality of second sub-electrodes on the second substrate, respectively.

9. The display panel according to claim 7, wherein the anti-peeping electrode comprises the plurality of first sub-electrodes, orthographic projections of the plurality of first sub-electrodes on the second substrate and orthographic projections of the plurality of second sub-electrodes on the second substrate do not overlap.

10. The display panel according to claim 4, wherein the anti-peeping electrode comprises the plurality of first sub-electrodes, at least one of the plurality of first sub-electrodes has a width in a range of about 3.5 μm to about 6.5 μm, and an interval between adjacent first sub-electrodes is in a range of about 1.5 μm to about 5.5 μm.

11. The display panel according to claim 1, wherein the anti-peeping electrode has a thickness in a range of about 100 Å to about 1000 Å.

12. The display panel according to claim 1, wherein the anti-peeping electrode comprises a transparent conductive material.

13. The display panel according to claim 3, wherein the liquid crystal layer comprises positive liquid crystals, the first voltage difference is in a range from about 2.8V to about 4.5V, and the second voltage difference is less than about 2.5V.

14. The display panel according to claim 3, wherein the liquid crystal layer comprises negative liquid crystals, and wherein the first voltage difference is in a range of about 6V to about 15V, and the second voltage difference is less than about 3V.

15. A display apparatus comprising the display panel according to claim 1.

16. An anti-peeping method for the display panel according to claim 2, the method comprising:
controlling the voltage difference between the anti-peeping electrode and the first electrode or the second electrode to operate the display panel in the anti-peeping mode or the non-anti-peeping mode.

17. The anti-peeping method according to claim 16, wherein controlling the voltage difference between the anti-peeping electrode and the first electrode or the second electrode to operate the display panel in the anti-peeping mode comprises:
generating a first voltage difference between the anti-peeping electrode and the first electrode or the second electrode.

18. The anti-peeping method according to claim 17, wherein controlling the voltage difference between the anti-peeping electrode and the first electrode or the second electrode to operate the display panel in the non-anti-peeping mode comprises:
generating a second voltage difference which is smaller than the first voltage difference between the anti-peeping electrode and the first electrode or the second electrode, or
applying no voltage on the anti-peeping electrode.

19. The anti-peeping method according to claim 18, wherein in a case where the liquid crystal layer comprises positive liquid crystals, the first voltage difference is in a range from about 2.8V to about 4.5V and the second voltage difference is less than about 2.5V; and in the case where the liquid crystal layer comprises negative liquid crystals, the first voltage difference is in a range from about 6V to about 15V and the second voltage difference is less than about 3V.

20. The anti-peeping method according to claim 16, the method comprising:
applying a voltage of Xₒₚ V on the common electrode;
applying a DC voltage on the anti-peeping electrode; and
applying an AC voltage on the pixel electrode, the AC voltage varying in a range between 0V to 2XₒₚV,
wherein Xₒₚ is a voltage of the pixel electrode corresponding to the maximum brightness of the display panel.
